(19) United States
(12) Patent Application Publication
(10) Pub. No.: US 2012/0019603 A1
(43) Pub. Date: Jan. 26, 2012

(54) LIQUID DISCHARGE HEAD AND MANUFACTURING METHOD THEREOF

(76) Inventors: Yasukazu NIHEI, Ashigara-Kami-Gun (JP); Kazuo SANADA, Ashigara-Kami-Gun (JP)

(21) Appl. No.: 13/249,389

(22) Filed: Sep. 30, 2011

Related U.S. Application Data
(62) Division of application No. 11/063,572, filed on Feb. 24, 2005, now abandoned.

(30) Foreign Application Priority Data
Feb. 25, 2004 (JP) 2004-49590

(51) Int. Cl. B41J 2/045

(52) U.S. Cl. 347/68

(57) ABSTRACT

The liquid discharge head comprises: a diaphragm; a first piezoelectric member which is formed on a first surface of the diaphragm, the first piezoelectric member driving the diaphragm; and a pressure chamber dividing wall which is formed on a second surface of the diaphragm opposite to the first surface, wherein the first piezoelectric member and the pressure chamber dividing wall are formed by a deposition method.

This application is a Divisional of co-pending application Ser. No. 11/063,572 filed on Feb. 24, 2005, and for which priority is claimed under 35 U.S.C. §120; and this application claims priority of Application No. 2004-49590 filed in Japan on Feb. 25, 2004 under 35 U.S.C. §119; and the entire contents of all are hereby incorporated by reference.

### BACKGROUND OF THE INVENTION

1. Field of the Invention

The present invention relates to a liquid discharge head and a method for manufacturing a liquid discharge head, and more particularly to a liquid discharge head and a method for manufacturing a liquid discharge head whereby liquid is discharged by causing a diaphragm to be deformed by means of a piezoelectric member.

2. Description of the Related Art

There is a type of liquid discharge head that causes a diaphragm to be deformed by means of piezoelectric members and thereby causes liquid to be discharged, and there is another type of liquid discharge head that has pressure chamber dividing walls composed of piezoelectric members, causes the pressure chamber dividing walls, and thereby causes liquid to be discharged. Japanese Patent Application Publication Nos. 7-81055, 2001-191520, and 4-286650 disclose the latter type of liquid discharge heads.

In the method for manufacturing the inkjet head in which the pressure chamber dividing walls include piezoelectric members, it is common that the pressure chamber dividing walls are formed by bonding mutually piezoelectric members of a certain thickness.

Japanese Patent Application Publication No. 7-81055 discloses the inkjet head in which a plurality of pressure chamber dividing walls are arranged on a substrate. Each of the pressure chamber dividing walls is constituted by layered piezoelectric elements. Each of the piezoelectric elements comprises plate-shaped piezoelectric members that are polarized in the thickness direction and laminated together through electrically conductive layers. Each of hollow spaces formed by these pressure chamber dividing walls is covered by a lid, and thereby the pressure chamber is formed. The volume of the pressure chamber is changed by causing the pressure chamber dividing walls formed by the piezoelectric elements to deform in the thickness direction, and thereby ink droplets are discharged through an ink discharge port. The pressure chamber dividing walls and the substrate are fixed together by means of an adhesive.

Japanese Patent Application Publication No. 2001-191520 discloses the inkjet head in which a ring-shaped piezoelectric element having a cut-away center is provided between a restrictor plate and a nozzle plate, and a circular cylindrical pressure chamber is formed inside this ring-shaped piezoelectric element. By applying voltage to the ring-shaped piezoelectric element, the ring-shaped piezoelectric element (namely, the pressure chamber) is caused to deform in the radial direction, so that ink droplets are discharged through a nozzle formed in the nozzle plate. An intermediate member made of a highly elastic and readily deformable material is arranged between the ring-shaped piezoelectric element and the restrictor plate or the nozzle plate so that the intermediate member can be deformed in accordance with the deformation of the ring-shaped piezoelectric element.

One of the common techniques used to achieve a three-dimensional structure in order to form ink chambers is a machining method, such as dicing. Japanese Patent Application Publication No. 4-286650 discloses the inkjet head in which ink flow paths (pressure chambers) are formed by bonding together upper and lower electrode ceramic plates, on which a required number of grooves are cut by rotation of a diamond cutting disk or by using a laser.

On the other hand, recently, in the field of the micro electrical mechanical systems (MEMS), it is considered that the devices using piezoelectric ceramics, such as sensors and actuators, have reached a higher level of integration and these elements are fabricated by a film formation that is suitable for practical use. As a case in point, an aerosol deposition method is known as a deposition technique for ceramics, a metal, or the like (see, for example, Jun Akedo “Towards next-generation mechanical design, No. 3, High-speed ceramic coating based on the impact-adhesion phenomenon of ultra-fine particles”, Mechanical Design, No. 45, Vol. 6 (pp. 92-96), Nikkan Kogyo Shinbunsha (May 2001) Japan). In the aerosol deposition method, aerosol is made from powder of raw material, the aerosol is sprayed onto a substrate, and a film is formed on the substrate by deposition of the powdered material due to its impact energy.

However, in an inkjet head which is formed by bonding together piezoelectric members of a certain thickness, or by creating a three-dimensional structure by means of processing for forming the ink chambers and the like, it is difficult to achieve downsizing by making thinner film structures and finer structures.

For example, low power consumption can be achieved in laminated piezoelectric members by reducing the thickness of each layer of the piezoelectric members and increasing the number of layers used. However, in this case of utilizing commonly used bulk piezoelectric members and green-sheet piezoelectric members, it is difficult to achieve film thicknesses below several tens micrometers. Even supposing that thinner films could be achieved by grinding, this is not necessarily appropriate for productivity in terms of yield issues such as the number of processing steps and uniformity of thickness.

On the other hand, in a thin film piezoelectric member such as a sputtered film, it is difficult to obtain film thicknesses above several micrometers. Furthermore, since common piezoelectric members have a low withstand voltage, it is difficult to apply high voltage to a piezoelectric member of reduced film thickness. Hence, a thin film having high withstand voltage is required.

Achieving fine three-dimensional structuring of ink chamber structure is important in order to achieve the high-density required for an inkjet head yielding a high image quality. However, with structuring based on the common processing, it is difficult to obtain a fine structure due to problems of machining accuracy and stress damages such as breakages and warping.

Moreover, in a structure in which piezoelectric members are bonded by means of an adhesive, there has been a problem of uneven discharge pressure in the head, due to variations in the bonding layer and/or variations in the bonding strength. Furthermore, since the adhesive itself is an organic material, there have been problems in that the bonding force is liable to change over time as well as stress-related change in properties over time. Hence, improvements in durability are required.

Furthermore, if a system adopts piezoelectric driving by means of only the pressure chamber dividing walls or only the diaphragms, then in the case of a high-density head in particular, low torque is obtained due to the small size of the piezoelectric member, the head cannot be used with high-viscosity inks, and it is difficult to achieve high torque in a high-density head. Furthermore, it is difficult to make individual fine pressure adjustments in order to modify the size of the discharged droplet or to improve refilling performance. In particular, there is a concern that, in a head of a large size, irregularities in ink discharge and/or refilling will occur if all of the piezoelectric elements are driven together. Furthermore, if a high-viscosity ink is used, then it is difficult to control all of the ink-related factors involved in the discharge and the refilling, in each single pressure chamber, by driving a single piezoelectric element.

### SUMMARY OF THE INVENTION

The present invention has been made in view of the aforementioned circumstances, and it is an object of the present invention to provide a liquid discharge head and a method for manufacturing a liquid discharge head, whereby warping of diaphragms can be suppressed, miniaturization of the three-dimensional structure, such as the ink chamber structure, and high-density arrangement of the nozzles can be achieved readily, and furthermore, high torque can be achieved readily by making it possible to apply high voltage to the piezoelectric members.

In order to attain the aforementioned object, the present invention is directed to a liquid discharge head, comprising: a diaphragm; a first piezoelectric member which is formed on a first surface of the diaphragm, the first piezoelectric member driving the diaphragm; and a pressure chamber dividing wall which is formed on a second surface of the diaphragm opposite to the first surface, wherein the first piezoelectric member and the pressure chamber dividing wall are formed by a deposition method.

According to the present invention, it is possible to cancel out the stress distortion in the case of the deposition, and the warping of the diaphragm can be eliminated or reduced, since the first piezoelectric member and the pressure chamber dividing wall are formed on both surfaces (the first surface and the second surface) of the diaphragm, respectively. Consequently, the heat treatment (the annealing) step for removing the internal stress can be omitted, or the heat treatment time can be shortened. Furthermore, it is possible to achieve a fine three-dimensional structure, by forming the first piezoelectric member and the pressure chamber dividing wall as the patterned films according to the deposition method. Moreover, in this case, since no step for bonding together the diaphragm and the first piezoelectric member or the pressure chamber dividing wall is required, it is substantially possible to resolve the problems of the non-uniformity, the reduced reliability, and the instability of the operation in the plane of the head due to the variation in the thickness of the adhesive and the degradation of the material over time. Beneficial effects are obtained, in particular, in the case of the piezoelectric head having a large size and/or high-density nozzles where it is difficult to control bonding-variation in the bonding process. Moreover, since the yield rate is increased by cutting the number of bonding processes and eliminating bonding variation, significant cost-related benefits can be expected.

Preferably, the pressure chamber dividing wall is made of a piezoelectric material. According to the present invention, the raw material of the first piezoelectric member and the raw material of the pressure chamber dividing wall formed by the deposition method are same, so that it is possible to further prevent warping.

Preferably, the pressure chamber dividing wall is provided with an electrode and serves as a second piezoelectric member. According to the present invention, by adopting the two piezoelectric members of the first and second piezoelectric members, the grate deformation and torque can be achieved even if the piezoelectric members are small in size due to the high-density arrangement of nozzles.

Preferably, the first piezoelectric member and the pressure chamber dividing wall are formed by an aerosol deposition method. According to the present invention, by using the aerosol deposition method as the deposition method, it is possible to achieve a layered structure for the piezoelectric members having a thickness of approximately several micrometers to several tens micrometers. Furthermore, since high voltage can be applied to the piezoelectric members due to the high withstand voltage of the piezoelectric members formed by the aerosol deposition method, it may be possible to increase the torque so that the head can be also compatible for use with the high-viscosity ink. In addition, the high allowable voltage significantly contributes to increasing the durability of the piezoelectric member.

In order to attain the aforementioned object, the present invention is also directed to a liquid discharge head, comprising: a diaphragm; a first piezoelectric member which is formed on a first surface of the diaphragm, the first piezoelectric member driving the diaphragm; and a second piezoelectric member which is formed on a second surface of the diaphragm opposite to the first surface, the second piezoelectric member constituting a pressure chamber dividing wall.

According to the present invention, by adopting the two piezoelectric members of the first and second piezoelectric members, the grate deformation and torque can be achieved even if the piezoelectric members are small in size due to the high-density arrangement of nozzles.

Preferably, the first piezoelectric member is provided with a first electrode; the second piezoelectric member is provided with a second electrode; and the first piezoelectric member and the second piezoelectric member are driven through the first electrode and the second electrode independently from each other. According to the present invention, since the first piezoelectric member and the second piezoelectric member can be driven independently from each other, the modulations and the fine adjustments can be applied to the ink discharge operation. Hence, the modulation of the ink droplet size can be controlled, the refilling performance can be stabilized, and the drying of the ink can be suppressed by causing the so-called meniscus vibration.

Preferably, the first piezoelectric member deforms in a d₃₁ mode, and the second piezoelectric member deforms in a d₃₃ mode. According to the present invention, since the first piezoelectric member deforms in the d₃₁ mode, the first piezoelectric member causes the diaphragm to bend, and changes the volume of the pressure chamber. On the other hand, since the second piezoelectric member deforms in the d₃₃ mode, the second piezoelectric member causes the pressure chamber dividing wall to expand and contract in the back-and-forth direction, and also changes the volume of the pressure chamber.

In order to attain the aforementioned object, the present invention is also directed to a method for manufacturing a liquid discharge head by spraying aerosol containing raw material powder onto a diaphragm and depositing the powder on the diaphragm according to an aerosol deposition method, comprising the steps of: forming a piezoelectric member on a first surface of the diaphragm by the aerosol deposition method; forming an individual electrode on the piezoelectric member by the aerosol deposition method; and forming a pressure chamber dividing wall on a second surface of the diaphragm opposite to the first surface by the aerosol deposition method.

Preferably, the step of forming the pressure chamber dividing wall comprises the steps of: forming a piezoelectric member by depositing powder of a piezoelectric material; and forming an electrode by depositing powder of a conductive material.

According to the present invention, since the first piezoelectric member is formed on one surface of the diaphragm and the pressure chamber dividing wall is formed on another surface of the diaphragm, it is possible to cancel out the stress distortion due to the deposition, and hence the warping of the diaphragm can be eliminated or reduced. Moreover, by forming the liquid discharge head by means of the deposition method, the miniaturization of the three-dimensional structure, such as the ink chamber structure, and the high-density arrangement of the nozzles can be achieved readily, and furthermore the steps for bonding the piezoelectric member and/or the pressure chamber dividing wall onto the diaphragm can be to omitted.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus using a liquid discharge head according to an embodiment of the present invention;

FIG. 2 is a plan view of the principal components in the peripheral area of a print unit in the inkjet recording apparatus in FIG. 1;

FIG. 3 is a schematic drawing showing a film formation device to carry out an aerosol deposition method;

FIGS. 4A to 4C are diagrams for describing a method for forming a film for a single-layer pressure chamber dividing wall onto a diaphragm according to the aerosol deposition method;

FIG. 5 is a diagram showing a state where the pressure chamber dividing walls and diaphragm driving devices for driving the diaphragm are formed on surfaces of the diaphragm;

FIG. 6 is a principal cross-sectional diagram of the liquid discharge head;

FIGS. 7A to 7C are diagrams for describing a method for forming films for a multiple-layer pressure chamber dividing wall onto a diaphragm according to the aerosol deposition method; and

FIG. 8 is a diagram for describing a method for forming a film for a single-layer pressure chamber dividing wall by means of mask patterning according to the aerosol deposition method.

### DETAILED DESCRIPTION OF THE PREFERRED EMBODIMENTS

### General Configuration of an Inkjet Recording Apparatus

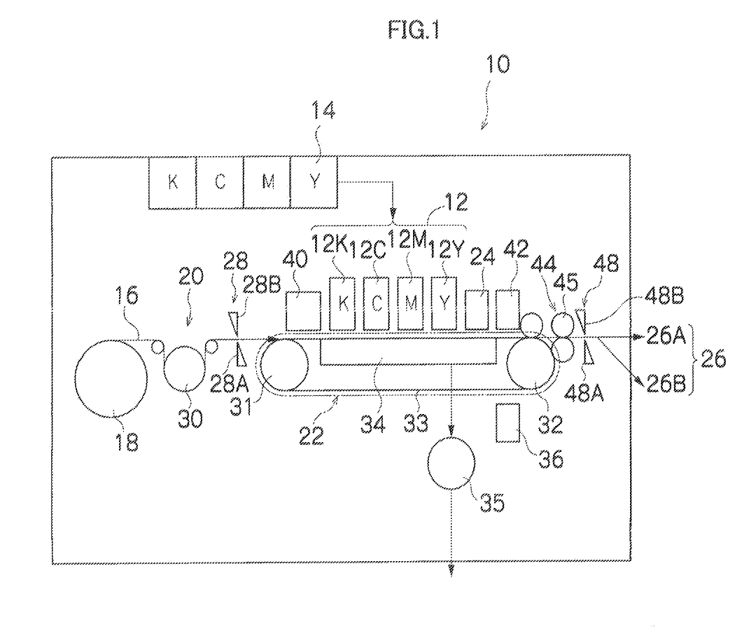

Below described is a general configuration of an inkjet recording apparatus provided with a liquid discharge head according to an embodiment of the present invention. FIG. 1 is a general schematic drawing of the inkjet recording apparatus. As shown in FIG. 1, the inkjet recording apparatus 10 comprises: a printing unit 12 having a plurality of print heads 12K, 12C, 12M, and 12Y for ink colors of black (K), cyan (C), magenta (M), and yellow (Y), respectively; an ink storing and loading unit 14 for storing inks of K, C, M and Y to be supplied to the print heads 12K, 12C, 12M, and 12Y; a paper supply unit 18 for supplying recording paper 16; a decurling unit 20 for removing curl in the recording paper 16; a suction belt conveyance unit 22 disposed facing the nozzle face (ink-droplet discharge face) of the print unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut paper is used, the cutter 28 is not required.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1; and the suction chamber 34 provides suction with a fan 35 to generate a negative pressure, and the recording paper 16 is held on the belt 33 by suction.

The belt 33 is driven in the clockwise direction in FIG. 1 by the motive force of a motor (not shown) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

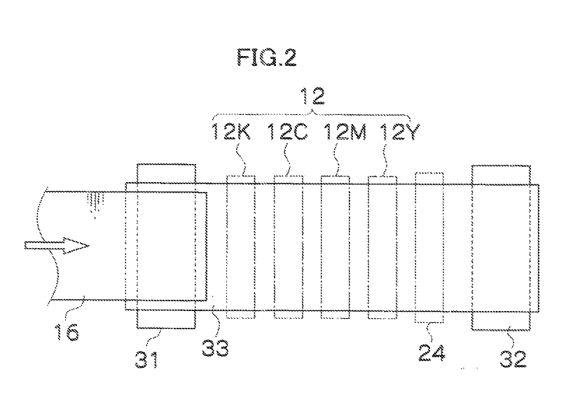

As shown in FIG. 2, the printing unit 12 forms a so-called full-line head in which a line head having a length that corresponds to the maximum paper width is disposed in the main scanning direction perpendicular to the delivering direction of the recording paper 16 (hereinafter referred to as the paper conveyance direction) represented by the arrow in FIG. 2, which is substantially perpendicular to a width direction of the recording paper 16. Each of the print heads 12K, 12C, 12M, and 12Y is composed of a line head, in which a plurality of ink-droplet discharge apertures (nozzles) are arranged along a length that exceeds at least one side of the maximum-size recording paper 16 intended for use in the inkjet recording apparatus 10, as shown in FIG. 2.

The print heads 12K, 12C, 12M, and 12Y are arranged in this order from the upstream side along the paper conveyance direction. A color print can be formed on the recording paper 16 by discharging the inks from the print heads 12K, 12C, 12M, and 12Y, respectively, onto the recording paper 16 while conveying the recording paper 16.

The print determination unit 24 has an image sensor for capturing an image of the ink-droplet deposition result of the print unit 12, and functions as a device to check for discharge defects such as clogs of the nozzles in the print unit 12 from the ink-droplet deposition results evaluated by the image sensor.

The post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

The heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathway in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48.

### Film Formation Method Based on the Aerosol Deposition Method

Next, a film formation method based on the aerosol deposition method as used in the manufacture of a liquid discharge head according to the present embodiment is described.

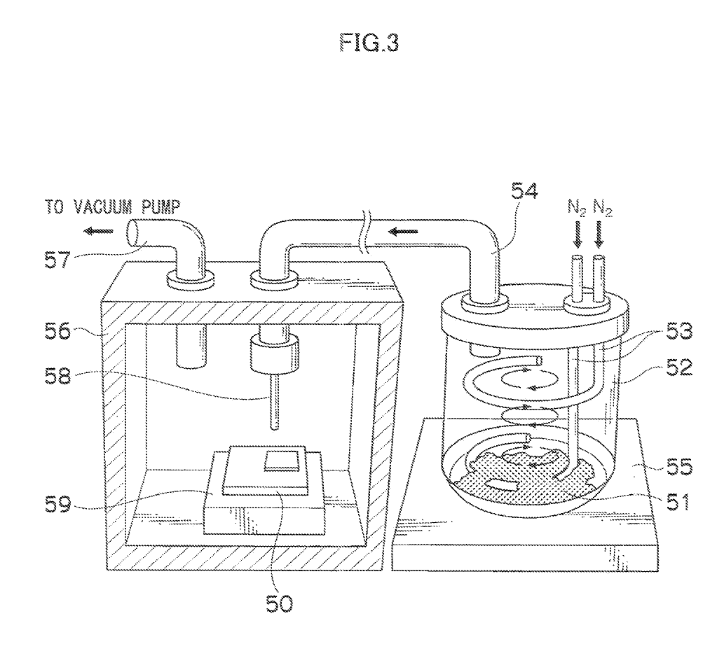

FIG. 3 is a schematic drawing showing a film formation device based on the aerosol deposition method. This film formation device has an aerosol-generating chamber 52 in which raw material powder 51 are accommodated. Here, the “aerosol” stands for fine particles of a solid or liquid dispersed in a gas.

The aerosol-generating chamber 52 is provided with carrier gas input sections 53, an aerosol output section 54, and a vibrating unit 55. Aerosol is generated by introducing a gas, such as nitrogen gas (N₂), via the carrier gas input sections 53, then blowing and lifting the raw material powder that is present in the aerosol-generating chamber 52. In this case, by applying a vibration to the aerosol-generating chamber 52 by means of the vibrating unit 55, the raw material powder is churned up and the aerosol is generated efficiently. The aerosol thereby generated is channeled through the aerosol output section 54 to a film formation chamber 56.

The film formation chamber 56 is provided with an evacuate tube 57, a nozzle 58, and a movable stage 59. The evacuate tube 57 is connected to a vacuum pump to evacuate the gas from the film formation chamber 56. The aerosol, which is generated in the aerosol generating chamber 52 and is conducted to the film formation chamber 56 via the aerosol output section 54, is sprayed from the nozzle 58 onto a substrate 50. In this way, the raw material powder collides with the substrate 50 and is thereby deposited thereon. The substrate 50 is mounted on the movable stage 59, which is capable of the three-dimensional movement, and hence the relative positions of the substrate 50 and the nozzle 58 can be adjusted by controlling the movable stage 59.

### Method for Manufacturing the Liquid Discharge Head

Next, a method for manufacturing the liquid discharge head according to the present embodiment is described.

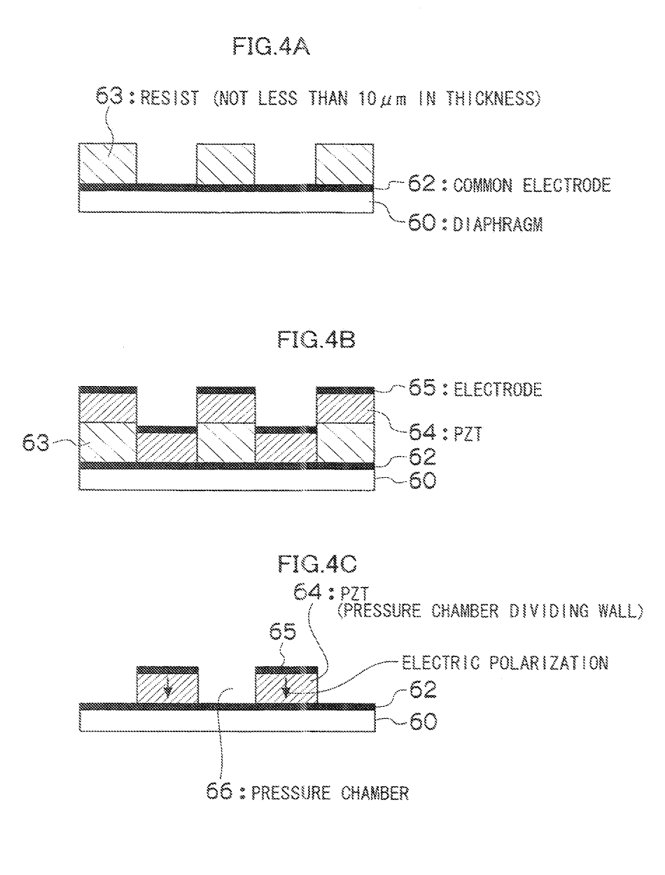

FIGS. 4A to 4C show a case where films composing the single-layer pressure chamber dividing walls 64 are formed on the diaphragm 60 according to the aerosol deposition method.

As shown in FIG. 4A, firstly, a common electrode 62 is formed on the diaphragm 60 of, for example, a ceramic oxide such as glass, SiO₂, and Al₂O₃. The common electrode 62 is made by forming a titanium oxide (TiO₂) layer serving as an adhesive layer by means of the sputtering or others, and then forming a platinum (Pt) layer, serving as a conductive layer, on the titanium oxide layer by means of the sputtering or others. Consequently, the common electrode 62 has a thickness of approximately 0.5 μm in total.

After forming the common electrode 62 on the diaphragm 60 as described above, resists 63 of the plan shape of the pressure chambers are formed on the common electrode 62 (i.e., the resist patterning). The thickness of the resists 63 is not less than 10 μm in this embodiment.

Next, as shown in FIG. 4B, films of the lead zirconate titanate (PZT) and electrodes are formed according to the aerosol deposition method. For example, PZT films 64 having a thickness of about 10 μm are formed by use of the monocrystalline fine particle PZT powder having an average particle size of about 0.3 μm and by means of driving the film formation device shown in FIG. 3. Subsequently, electrodes 65 are formed by sputtering or others. The electrodes 65 may also be formed by the aerosol deposition method.

Next, the resists 63 are dissolved by using acetone as shown in FIG. 4C, and the PZT films and the electrodes on the resists 63 are thereby lifted off. By this lift-off process, pressure chambers 66 are formed between the PZT films 64, the PZT films 64 function as pressure chamber dividing walls, and the electrodes 65 function as individual electrodes.

Next, heat treatment (annealing of the piezoelectric film) is carried out in order to remove the internal stress of the PZT films 64. The annealing is performed by maintaining the structure at 600° C. for one hour, for example. Next, the PZT films 64 are poled at the poling conditions of 100 to 200° C., 40 kV/cm, for example. More specifically, an electric field of 40 kV/cm is applied to the PZT films 64 at 100 to 200° C., thereby each of the PZT films 64 is polarized in the thickness direction as indicated by the arrow in FIG. 4C. When voltage is applied between the electrodes at the ends of the poled PZT film (the pressure chamber dividing wall) 64, the poled PZT film deforms in d₃₃ mode, in which the film expands and contracts in the thickness direction.

FIG. 5 shows a case where PZT films 72 are formed on the other surface of the diaphragm 60 according to the aerosol deposition method.

After forming the PZT films 64, which serve as the pressure chamber dividing walls, and others on one surface (the obverse) of the diaphragm 60 as illustrated in FIGS. 4A to 4C, the PZT films 72 for driving the diaphragm 60 are formed on the other surface (the reverse) of the diaphragm 60 at positions corresponding to the pressure chambers 66. More specifically, similarly to the method illustrated in FIGS. 4A and 4B, a common electrode 71 is formed, the resist patterning is performed, PZT films are formed according to the aerosol deposition method, electrodes are formed, and then the lift-off process is performed. Thus, the PZT films 72 and individual electrodes 73 are formed at positions corresponding to the pressure chambers 66.

Then, the annealing and poling processes are carried out. When voltage is applied between the common electrode 71 and each of the individual electrodes 73, each of the poled PZT films 72 deforms in d₃₁ mode, in which the film extends and contracts in the lengthwise direction, so that the diaphragm 60 can be driven.

In the present embodiment, the piezoelectric members (the PZT films) are formed on both surfaces of the diaphragm 60 by the aerosol deposition method as described above, and then the following effects are confirmed.

Since the aerosol deposition method is a method for depositing a high-density film by spraying powder at high speed, the residual stress is liable to occur in the film during the formation. Consequently, it has been confirmed that the diaphragm is liable to be pulled by the film and to bend. By annealing the film to relieve the stress, the bending of the diaphragm is improved. However, it has been confirmed that, if the films are formed by the aerosol deposition method on both of the surfaces of the diaphragm as in the present method, then the stress distortion is cancelled out mutually and there is no need to perform annealing. Hence, it has been confirmed that the forming films by the aerosol deposition method on both of the surfaces of a diaphragm, as in the present composition, is effective from the viewpoint of canceling out distortion. Moreover, since the heat treatment can be reduced, beneficial effects, such as increased design freedom and lower costs due to the reduced number of processing steps, can be expected.

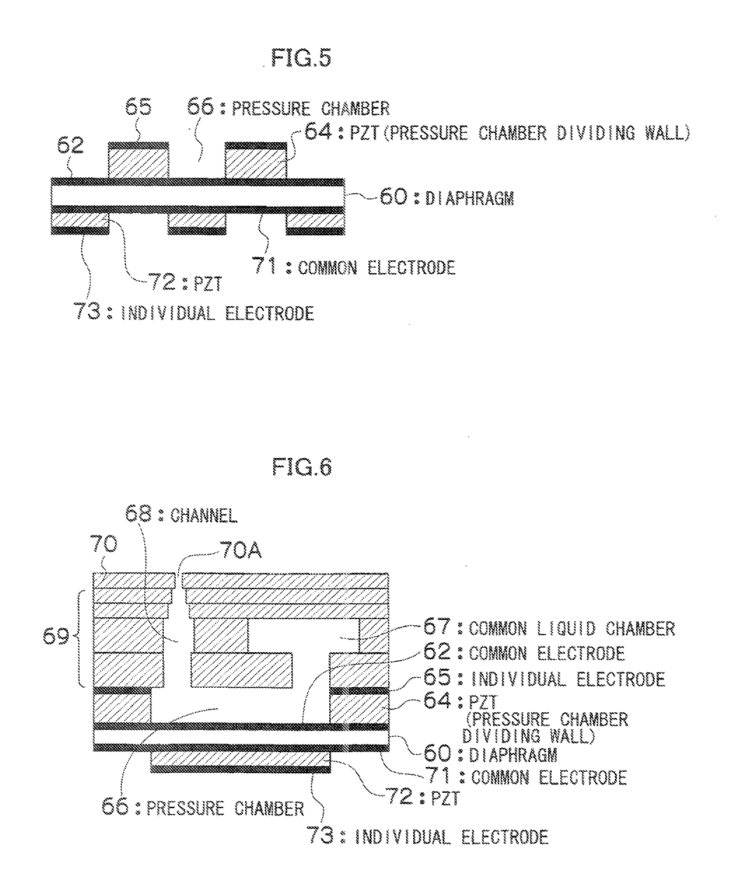

Next, as shown in FIG. 6, a layered substrate 69 is formed over the PZT films (the pressure chamber dividing walls) 64. The layered substrate 69 has a common liquid chamber 67 for supplying ink to the pressure chambers 66, a flow path 68 for discharging ink from each of the pressure chambers 66, and others. A nozzle plate 70 formed with nozzles 70A is bonded on the layered substrate 69. The layered substrate 69 may be also formed by the film formation using the aerosol deposition method.

It has been confirmed that it is possible to control the respective piezoelectric members independently by providing first and second drive devices. The first drive device applies a voltage between each of the individual electrodes 65 and the common electrode 62 on the faces of each of the pressure chamber dividing walls 64. The second drive device applies a voltage between the common electrode 71 and the individual electrode 73 on the faces of the PZT film 72.

More specifically, if the voltage is applied between each of the individual electrodes 65 and the common electrode 62 on the faces of each of the pressure chamber dividing walls 64 by means of the first drive device, then each of the pressure chamber dividing walls 64 to which the voltage is applied deforms in the d₃₃ mode (namely, it extends or contracts in the thickness direction), and the volume of the pressure chamber 66 is thereby changed. Furthermore, if the voltage is applied between each of the individual electrodes 73 and the common electrode 71 on the faces of the PZT film 72 corresponding to the pressure chamber 66 by means of the second drive device, then the PZT film 72 to which the voltage is applied deforms in the d₃₁ mode (namely, it extends or contracts in the lengthwise direction), the diaphragm 60 is thereby bent, and the volume of the pressure chamber 66 is thus changed.

In this way, in one pressure chamber 66, it is possible to combine the driving by the pressure chamber dividing wall 64 and the driving by the diaphragm 60, so that the adjustable range of the volume of the pressure chamber 66 can be increased. Hence, it is possible to make fine pressure adjustments at each of the pressure chambers, such as adjusting and controlling the ink droplet size, stabilizing the ink supply performance to the nozzle (refilling characteristics), and/or vibrating the meniscus of the ink in order to prevent the ink from drying.

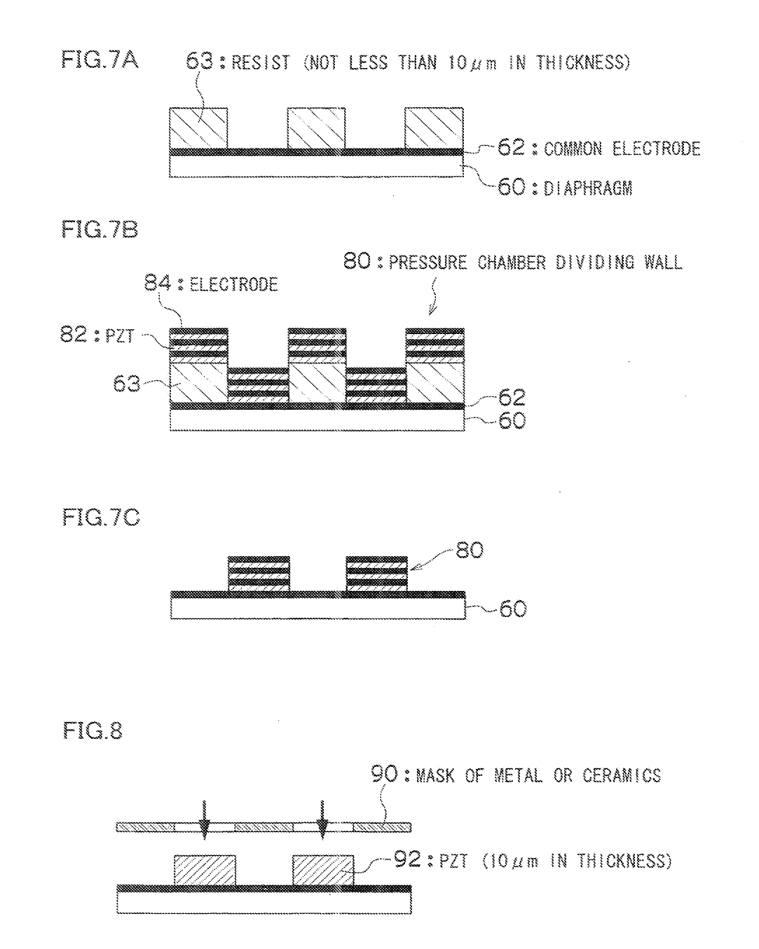

FIGS. 7A to 7C show a case where films forming multiple-layer pressure chamber dividing walls 80 are formed on the diaphragm 60 by the aerosol deposition method. Parts that are common to FIGS. 4A to 4C are denoted with the same reference numerals, and detailed description thereof is omitted here.

Each of the pressure chamber dividing walls 80 is formed by the layered film formation of PZT films and electrode films by the aerosol deposition method, as illustrated in FIGS. 7B and 7C. For example, each of the pressure chamber dividing walls 80 comprises the ten layers of PZT films 82, and electrode films 84 holding each of the PZT films 82 between them. Each of the PZT films 82 has approximately 5 μm thick and each of the electrode films 84 has approximately 0.5 μm thick.

The withstand voltage was measured for the film of the PZT formed by the aerosol deposition method (the aerosol deposition film) and the conventional film of the PZT (the conventional film). The withstand voltage is defined as the voltage at which partial shorting or element breakdown is clearly confirmed when the applied voltage is gradually increased. It was confirmed that the withstand voltage of the aerosol deposition film was 700 kV/cm, the withstand voltage of the sputtered film was 100 kV/cm, and the withstand voltage of a bulk PZT formed by a green-sheet method and the withstand voltage of a bulk PZT formed by sintering were approximately 10 kV/cm.

Hence, in the case of the layered piezoelectric member composed of the films of 5 μm thickness with the green-sheets or sintered bulk members (it is in fact relatively difficult to achieve this film thickness, but it is assumed here that it can be achieved by machining), the upper limit of the applied voltage is 5V. In the case of the sputtered film, the upper voltage limit is 50V when the film thickness is 5 μm. In the case of the aerosol deposition film, a huge allowable voltage range of 350V is achieved. The aerosol deposition film is also outstanding from the viewpoint of durability.

In the above-described embodiment, the patterned films are formed by the resist patterning and the lift-off process in the film formation by the aerosol deposition method; however, the present invention is not limited to this. For instance, as shown FIG. 8, it is also possible to form patterned PZT films 92, which serve as the pressure chamber dividing walls, onto the diaphragm 60 by the aerosol deposition method with mask patterning using a mask 90 of metal, ceramic, and the like.

Moreover, it is described in the above-mentioned embodiments that the liquid discharge head relevant to the present invention is applied to a line-type inkjet head that discharges ink onto a recording paper, whereas the invention is not limited to this. The present invention may also be applied to a shuttle-type head that moves back and forth reciprocally in a direction orthogonal to the conveyance direction of the print medium. Furthermore, the liquid discharge head relevant to the present invention may be applied to an image forming head that sprays a treatment liquid or water onto a recording medium, and a liquid discharge head for forming an image recording medium by spraying a coating liquid onto a base material.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid discharge head, comprising:
a diaphragm;
a first piezoelectric member which is formed on a first surface of the diaphragm, the first piezoelectric member driving the diaphragm; and
a pressure chamber dividing wall which is formed on a second surface of the diaphragm opposite to the first surface,
wherein the first piezoelectric member and the pressure chamber dividing wall are formed by a deposition method.

2. The liquid discharge head as defined in claim 1, wherein the pressure chamber dividing wall is made of a piezoelectric material.

3. The liquid discharge head as defined in claim 2, wherein the pressure chamber dividing wall is provided with an electrode and serves as a second piezoelectric member.

4. The liquid discharge head as defined in claim 3, wherein the first piezoelectric member deforms in a d₃₁ mode, and the second piezoelectric member deforms in a d₃₃ mode.

5. The liquid discharge head as defined in claim 2, wherein:
the first piezoelectric member is provided with a first electrode;
the pressure chamber dividing wall is provided with a second electrode and serves as a second piezoelectric member; and
the first piezoelectric member and the second piezoelectric member are driven through the first electrode and the second electrode independently from each other.

6. The liquid discharge head as defined in claim 5, wherein the first piezoelectric member deforms in a d₃₁ mode, and the second piezoelectric member deforms in a d₃₃ mode.

7. The liquid discharge head as defined in claim 1, wherein the first piezoelectric member and the pressure chamber dividing wall are formed by an aerosol deposition method.

8. A liquid discharge head, comprising:
a diaphragm;
a first piezoelectric member which is formed on a first surface of the diaphragm, the first piezoelectric member driving the diaphragm; and
a second piezoelectric member which is formed on a second surface of the diaphragm opposite to the first surface, the second piezoelectric member constituting a pressure chamber dividing wall.

9. The liquid discharge head as defined in claim 8, wherein:
the first piezoelectric member is provided with a first electrode;
the second piezoelectric member is provided with a second electrode; and
the first piezoelectric member and the second piezoelectric member are driven through the first electrode and the second electrode independently from each other.

10. The liquid discharge head as defined in claim 9, wherein the first piezoelectric member deforms in a d₃₁ mode, and the second piezoelectric member deforms in a d₃₃ mode.
